(19) United States
(12) Patent Application Publication
(10) Pub. No.: US 2016/0049163 A1
(43) Pub. Date: Feb. 18, 2016

(54) METHOD, APPARATUS AND SYSTEM FOR ISOLATING MICROPHONE AUDIO

(71) Applicant: THOMSON LICENSING, Issy de Moulineaux (FR)

(72) Inventors: Efstratios IOANNIDIS, Boston, MA (US); Gregory Charles HERLEIN, San Francisco, CA (US); Christophe DIOT, Paris (FR)

(21) Appl. No.: 14/781,957

(22) PCT Filed: May 13, 2013
(86) PCT No.: PCT/US13/40693

§ 371 Date: Oct. 2, 2015

(51) Int. Cl. G10L 25/48; G06Q 20/08; H04R 3/00; G06Q 30/02; G10L 25/18; G10L 25/21

(52) U.S. Cl. CPC G10L 25/48; G10L 25/18; G10L 25/21; H04R 3/005; G06Q 30/0251; G06Q 20/08

(57) ABSTRACT

A method, apparatus and system for isolating microphone audio include recording audio using at least two microphones using a target microphone of the array of microphones, determining an attenuation factor for audio originating from respective locations of other microphones using a target microphone of the array of microphones, determining a delay factor for audio originating from respective locations of other microphones of the array of microphones, and implementing the determined attenuation factor and delay factor for removing audio originating from respective locations of the other microphones from an audio signal captured by the target microphone to isolate the audio signal captured by the target microphone. The method, apparatus and system further include processing the isolated audio signal of the target microphone to determine audio attributes of the isolated audio signal of the target microphone and determining using the audio attributes, respective sources of audio in the isolated audio signal.

This application is related to International PCT Application No. PCT/US12/072083, filed Dec. 28, 2012, the entire contents of which are hereby incorporated by reference for all purposes into this application.

### FIELD OF THE INVENTION

The present invention generally relates to isolation of microphone audio and, more particularly, to a method, apparatus and system for removing noise from microphone signals for isolating audio.

### BACKGROUND OF THE INVENTION

Noise suppression is often required in many communication systems and content distribution devices to suppress noise to improve communication quality and media comprehension. Noise suppression can be achieved using various techniques, some of which can be classified as single microphone techniques and array microphone techniques.

Array microphone noise reduction techniques use multiple microphones placed at different locations and separated from each other by some minimum distance to form a beam. Conventionally, the beam is used to pick up speech that is then used to reduce the amount of noise picked up outside the beam. Thus, the array microphone techniques can suppress non-stationary noise. The isolation of microphone signals via noise suppression can be used, for example, in a retail advertising environment to identify shopper demographics and/or purchase numbers.

Multiple microphones, however, also themselves create more noise. In addition, such techniques do not use configuration parameters of a system and known audio signals to enable noise cancellation as described herein.

### SUMMARY OF THE INVENTION

Embodiments of the present invention address the deficiencies of the prior art by providing a method, apparatus and system for isolating microphone signals.

In an embodiment of the present invention a method includes recording audio using at least two microphones using a target microphone of the array of microphones, determining an attenuation factor for audio originating from respective locations of other microphones using a target microphone of the array of microphones, determining a delay factor for audio originating from respective locations of other microphones of the array of microphones, and implementing the determined attenuation factor and delay factor for removing audio originating from respective locations of the other microphones from an audio signal captured by the target microphone to isolate the audio signal captured by the target microphone. The method, apparatus and system further include processing the isolated audio signal of the target microphone to determine audio attributes of the isolated audio signal of the target microphone and determining using the audio attributes, respective sources of audio in the isolated audio signal.

In an alternate embodiment of the present invention, an apparatus includes a memory for storing program routines and data and a processor for executing the program routines. In such an embodiment, the apparatus is configured to record audio using at least two microphones, which comprise an array of microphones, use a target microphone of the array of microphones to determine an attenuation factor for audio originating from respective locations of other microphones of the array of microphones, use a target microphone of the array of microphones to determine a delay factor for audio originating from respective locations of other microphones of the array of microphones, implement the determined attenuation factor and delay factor for removing audio originating from respective locations of the other microphones of the array of microphones from an audio signal captured by the target microphone to isolate the audio signal captured by the target microphone, process the isolated audio signal of the target microphone to determine audio attributes of the isolated audio signal of the target microphone, and determine, using the audio attributes, respective sources of audio in the isolated audio signal of the target microphone.

In an alternate embodiment of the present invention, a system includes at least two microphones comprising an array of microphones, at least one audio source, an apparatus including a memory for storing program routines and data, and a processor for executing the program routines. In such a system, the apparatus is configured to record audio using at least two microphones, which comprise an array of microphones, use a target microphone of the array of microphones to determine an attenuation factor for audio originating from respective locations of other microphones of the array of microphones, use a target microphone of the array of microphones to determine a delay factor for audio originating from respective locations of other microphones of the array of microphones, implement the determined attenuation factor and delay factor for removing audio originating from respective locations of the other microphones of the array of microphones from an audio signal captured by the target microphone to isolate the audio signal captured by the target microphone, process the isolated audio signal of the target microphone to determine audio attributes of the isolated audio signal of the target microphone, and determine, using the audio attributes, respective sources of audio in the isolated audio signal of the target microphone

### BRIEF DESCRIPTION OF THE DRAWINGS

The teachings of the present invention can be readily understood by considering the following detailed description in conjunction with the accompanying drawings, in which:

FIG. 1 depicts a high level block diagram of a content distribution system in which an embodiment of the present invention can be applied;

FIG. 2 depicts a high level block diagram of an in-store advertising network for providing in-store advertising in which an embodiment of the present invention can be applied;

FIG. 3 depicts a high level block diagram of an apparatus for isolating microphone audio in accordance with an embodiment of the present invention; and

FIG. 4 depicts a flow diagram of a method for isolating microphone audio in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method, apparatus and system for isolating microphone audio. Although the present invention will be described primarily within the context of an in-store retail advertising network environment and advertising content distribution and specifically a check-out application for isolating speech, the specific embodiments of the present invention should not be treated as limiting the scope of the invention. It will be appreciated by those skilled in the art and informed by the teachings of the present invention that the concepts of the present invention can be advantageously applied to any environment in which the isolation of any audio, such as voices, is desirable such as fast food restaurants, bank teller counters, etc.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof.

Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

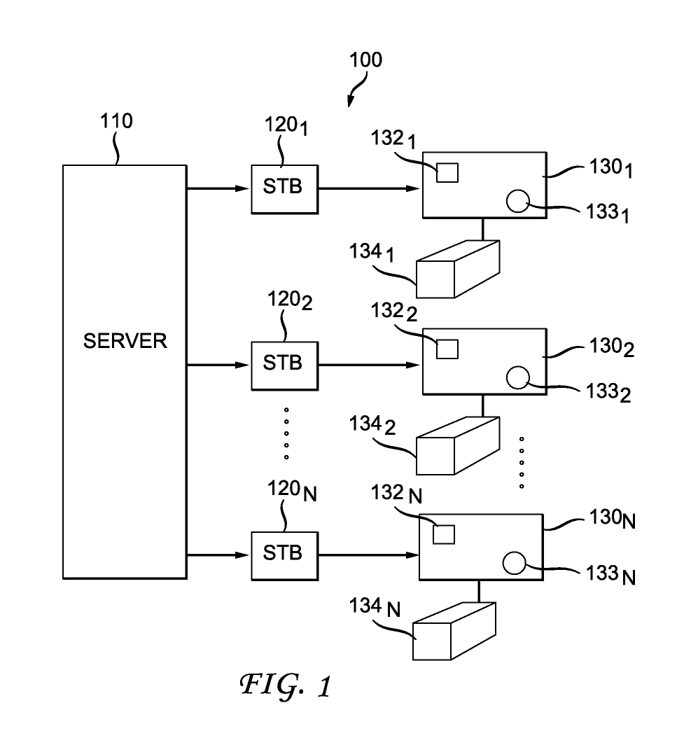

FIG. 1 depicts a high level block diagram of a content distribution system in which an embodiment of the present invention can be applied. The content distribution system 100 of FIG. 1 illustratively comprises a checkout advertising distribution system including, illustratively one server 110, a plurality of receiving devices such as tuning/decoding means (illustratively set-top boxes (STBs)) 120₁-120ₙ, and a respective display 130₁-130ₙ for each of the set-top boxes 120₁-120ₙ. As depicted in FIG. 1, the displays 130 each include a respective microphone 132₁-132ₙ and at least one speaker 133₁-133ₙ and are located in the proximity of a respective checkout lane 134₁-134ₙ. In the content distribution system 100 of FIG. 1, the microphones 132 of the displays 130 comprise an array of microphones. In such a system as the system 100 of FIG. 1, the microphones 132 are typically used to verify playout of the content on the displays 130 and can further be used for noise cancellation purposes.

Although in the system 100 of FIG. 1, each of the plurality of set-top boxes 120₁-120ₙ, is illustratively connected to a single, respective display, in alternate embodiments of the present invention, each of the plurality of set-top boxes 120₁-120ₙ, can be connected to more than a single display. That is, in alternate embodiments of the invention, displays of a plurality of checkout lanes can be controlled and in communication with a single set-top box. In addition, although in the content distribution system 100 of FIG. 1 the tuning/decoding means are illustratively depicted as set-top boxes 120, in alternate embodiments of the present invention, the tuning/decoding means of the present invention can comprise alternate tuning/decoding means such as a tuning/decoding circuit integrated into the displays 130 or other stand alone tuning/decoding devices and the like. Even further, receiving devices of the present invention can include any devices capable of receiving content such as audio, video and/or audio/video content.

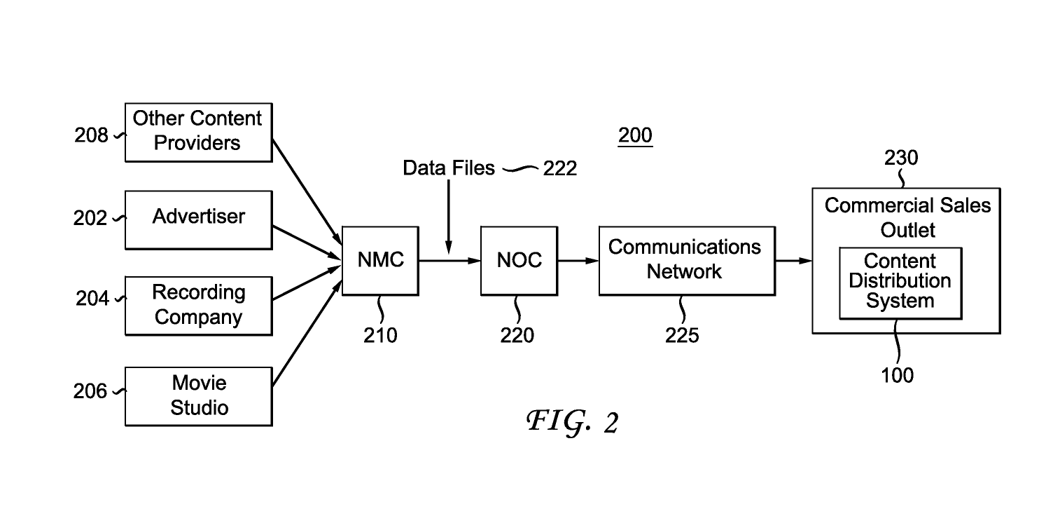

In one embodiment of the present invention, the content distribution system 100 of FIG. 1 can be a part of an in-store advertising network. For example, FIG. 2 depicts a high level block diagram of an in-store advertising network 200 for providing in-store advertising. In the advertising network 200 of FIG. 2, the advertising network 200 and distribution system 100 employ a combination of software and hardware that provides cataloging, distribution, presentation, and usage tracking of music recordings, home video, product demonstrations, advertising content, and other such content, along with entertainment content, news, and similar consumer informational content in an in-store setting. The content can include content presented in compressed or uncompressed video and audio stream format (e.g., MPEG4/MPEG4 Part 10/AVC-H.264, VC-1, Windows Media, etc.), although the present system should not be limited to using only those formats.

In one embodiment of the present invention, software for controlling the various elements of the in-store advertising network 200 and the content distribution system 100 can include a 32-bit operating system using a windowing environment (e.g., MS-Windows™ or X-Windows operating system) and high-performance computing hardware. The advertising network 200 can utilize a distributed architecture and provides centralized content management and distribution control via, in one embodiment, satellite (or other method, e.g., a wide-area network (WAN), the Internet, a series of microwave links, or a similar mechanism) and in-store modules.

As depicted in FIG. 2, the content for the in-store advertising network 200 and the content distribution system 100 can be provided from an advertiser 202, a recording company 204, a movie studio 206 or other content providers 208. An advertiser 202 can be a product manufacturer, a service provider, an advertising company representing a manufacturer or service provider, or other entity. Advertising content from the advertiser 202 can consist of audiovisual content including commercials, “info-mercials”, product information and product demonstrations, and the like.

A recording company 204 can be a record label, music publisher, licensing/publishing entity (e.g., BM I or ASCAP), individual artist, or other such source of music-related content. The recording company 204 provides audiovisual content such as music clips (short segments of recorded music), music video clips, and the like. The movie studio 206 can be a movie studio, a film production company, a publicist, or other source related to the film industry. The movie studio 106 can provide movie clips, pre-recorded interviews with actors and actresses, movie reviews, “behind-the-scenes” presentations, and similar content.

The other content provider 208 can be any other provider of video, audio or audiovisual content that can be distributed and displayed via, for example, the content distribution system 100 of FIG. 1.

In one embodiment of the present invention, content is procured via the network management center 210 (NMC) using, for example, traditional recorded media (tapes, CD's, videos, and the like). Content provided to the NMC 210 is compiled into a form suitable for distribution to, for example, the local distribution system 100, which distributes and displays the content at a local site.

The NMC 210 can digitize the received content and provide it to a Network Operations Center (NOC) 220 in the form of digitized data files 222. It will be noted that data files 222, although referred to in terms of digitized content, can also be streaming audio, streaming video, or other such information. The content compiled and received by the NMC 210 can include commercials, bumpers, graphics, audio and the like. All files are preferably named so that they are uniquely identifiable. More specifically, the NMC 210 creates distribution packs that are targeted to specific sites, such as store locations, and delivered to one or more stores on a scheduled or on-demand basis. The distribution packs, if used, contain content that is intended to either replace or enhance existing content already present on-site (unless the site's system is being initialized for the first time, in which case the packages delivered will form the basis of the site's initial content). Alternatively, the files may be compressed and transferred separately, or a streaming compression program of some type employed.

The NOC 220 communicates digitized data files 222 to, in this example, the content distribution system 100 at a commercial sales outlet 230 via a communications network 225. The communications network 225 can be implemented in any one of several technologies. For example, in one embodiment of the present invention, a satellite link can be used to distribute digitized data files 222 to the content distribution system 100 of the commercial sales outlet 230. This enables content to easily be distributed by broadcasting (or multicasting) the content to various locations. Alternatively, the Internet can be used to both distribute audiovisual content to and allow feedback from commercial sales outlet 230. Other ways of implementing communications network 225, such as using leased lines, a microwave network, or other such mechanisms can also be used in accordance with alternate embodiments of the present invention.

The server 110 of the content distribution system 100 is capable of receiving content (e.g., distribution packs) and, accordingly, distribute them in-store to the various receivers such as the set-top boxes 120 and displays 130. That is, at the content distribution system 100, content is received and configured for streaming. The streaming can be performed by one or more servers configured to act together or in concert. The streaming content can include content configured for various different locations or products throughout the sales outlet 230 (e.g., store). For example, respective set-top boxes 120 and displays 130 can be located at specific locations throughout the sales outlet 230 and respectively configured to display content and broadcast audio pertaining to products located within a predetermined distance from the location of each respective set-top box and display.

The various embodiments of the present invention provide a method, apparatus and system for isolating microphone signals. That is various embodiments of the present invention described herein are directed towards removing ambient noise from the signal of a microphone existing in a commercial checkout environment such that an audio or sounds originating at a respective checkout counter can be isolated. More specifically, various embodiments of the present invention described herein are directed towards removing ambient sounds from microphones contained in an array, for example in a plurality of display screens as depicted in FIG. 1, such that sounds received or detected by a microphone in a target display screen can be isolated. Again, although various embodiments of the present invention will be described primarily within the context of a commercial advertising network environment and advertising content distribution, the specific embodiments of the present invention should not be treated as limiting the scope of the invention.

In one embodiment of the present invention, a process for determining noise, such as sounds and other audio signals generated in adjacent checkout lanes of the content distribution system of FIG. 1, to be removed from at least one microphone in an array of microphones can be accomplished through, in one embodiment of the present invention, a beam-forming process/technique. For describing an embodiment of the present invention, let t be a timeslot at which microphones record a sound (e.g., every msec), yᵢ(t) be the signal received or detected by microphone at screen i at timeslot t, xᵢ(t) be the sound signal generated at counter i at timeslot t (including, for example, the conversation between the cashier and the customer at counter i, the scanning sounds made by the checkout machine, etc.), Tᵢⱼ be a weight value (delay parameter) based on time delay from counter i to counter j, and wᵢⱼ be a weight value (attenuation factor) based on the distance between counter i to counter j. As such, a microphone at position i receives a signal yᵢ that includes sounds from all counters which can be determined according to equation one (1), which follows:

$${y}_{i} ( t ) = {\sum }_{j = 1}^{n} {w}_{ij} {x}_{j} ( t - {T}_{ij} ) . \qquad ( 1 )$$

Again, in equation (1) wᵢⱼ is the attenuation factor from counter j to counter i and Tᵢⱼ is the delay parameter from counter j to counter i. As a result, to isolate the sound coming from counter i, the following processing takes place. Each display broadcasts the recorded signals yᵢ(t) to, for example, a processing device which, in various embodiments of the present invention, can reside at the set-top box 120, or a local or remote server such as the server 110 of the content distribution system 100 of FIG. 1 or the NMC 210 or NOC 220 of the in-store advertising network 200 of FIG. 2. Having these signals, to isolate the sound at counter i at time t (i.e. xᵢ(t)), the processing device solves the linear system of equation one (1). The unknowns in this system are the signals xᵢ at different timeslots t.

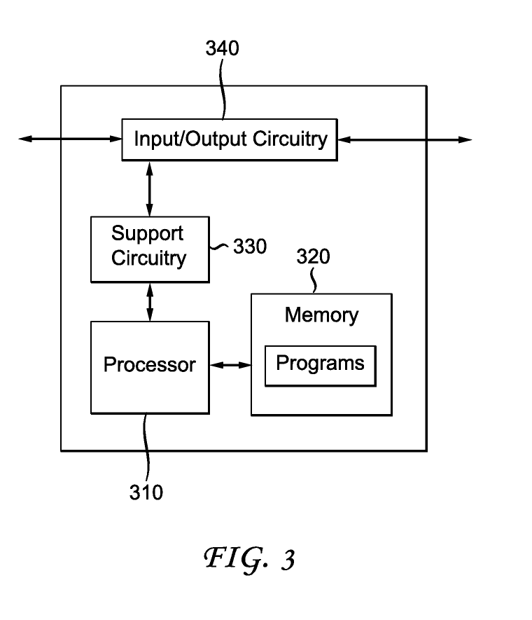

FIG. 3 depicts a high-level block diagram of a processing apparatus, which in various embodiments of the present invention can be a set-top box 120, or a local or remote server such as the server 110 of the content distribution system 100 of FIG. 1 or the NMC 210 or NOC 220 of the in-store advertising network 200 of FIG. 2. More specifically, the processing device of FIG. 3 illustratively comprises a processor 310 as well as a memory 320 for storing control programs, file information, stored signals and the like. The processor 310 cooperates with conventional support circuitry 330 such as power supplies, clock circuits, cache memory and the like as well as circuits that assist in executing the software routines stored in the memory 320. As such, it is contemplated that some of the process steps discussed herein as software processes may be implemented within hardware, for example, as circuitry that cooperates with the processor 310 to perform various steps. The processing apparatus also contains input-output circuitry 340 that forms an interface between various functional elements communicating with the processing apparatus.

Although the processing apparatus of FIG. 3 is depicted as a general purpose computer that is programmed to perform various control functions in accordance with the present invention, the invention can be implemented in hardware, for example, as an application specified integrated circuit (ASIC). As such, the process steps described herein are intended to be broadly interpreted as being equivalently performed by software executed by a processor, hardware, or a combination thereof. In addition, although the processing apparatus of FIG. 3 is depicted as a separate component, the functionalities of the processing device in accordance with the concepts and embodiments of the present invention described herein can be incorporated into an existing system component such as a set-top box, server and the like.

Returning to equation one (1) above, in one embodiment of the present invention, to determine the attenuation factor wᵢⱼ and the delay factor Tᵢⱼ, known checkout sounds or tones generated by, for example, the scanners at the checkout counters are used. That is, in such an embodiment, a checkout scanner tone is a known sound and comprises a predetermined volume. If each scanner generates a checkout tone at a known time (t₁), the microphone of a target display can detect the tones and communicate such information to, in one embodiment, an audio circuit in, for example a processing device or server of the present invention as described above.

In an alternate embodiment of the present invention in which local sounds are not known (i.e., the type and volume of audio generated locally is not known), a local microphone such as the microphone 132₁ of a respective checkout lane 134₁ can be used to record audio signals in its vicinity and using known techniques, such as beam-forming techniques and other audio signal processing techniques, can determine which audio signals are generated local to its vicinity and can also determine the volume and other physical properties of such locally generated audio signals. These determined parameters of the locally generated audio signals can then be used by a target microphone to determine attenuation and delay factors of such signals as described above. That is, in such embodiments, the locally generated audio signals as determined by respective microphones of an array can be used by a target microphone as known signals as described above to determine attenuation and delay factors of such signals as described above.

In one embodiment of the present invention, the audio circuit may comprise a discrete circuit card in, for example a display or a server of the present invention or may comprise a dedicated device such as the Network Audio Processor as described in co-pending U.S. patent application Ser. No. 12/733,214. The audio circuit of the present invention can compute the attenuation factor wᵤ and the delay factor Tᵢⱼ for each scanner at each checkout counter having the information regarding known sounds generated at the checkouts. More specifically, in one embodiment of the present invention, given that the scanning signal at position i is generated at time t₁, Tᵢⱼ can be computed as the number of timeslots between and the timeslot at which the scanning signal is first recorded at the microphone j. Alternatively, in an alternate embodiment of the present invention, the difference in timeslots between the first/highest peak across different recorded signals, rather than the beginning of the signal, can be used.

In one embodiment of the present invention, the attenuation factor wᵢⱼ is computed similarly. In particular, wᵢⱼ can be taken to be equal to one for all i. The factor wᵢⱼ is computed as the ratio of the signal at microphone j, at time t₁+Tᵢⱼ over the signal at microphone i at time t₁+Tᵢⱼ. In alternative embodiment of the present invention, the ratio of peaks or other positions in the waveform of the scanning sound can be used.

Once the attenuation factor and the delay factor Tᵢⱼ are computed, beam forming technique can be used so that sounds from the other checkout counters are removed from the audio signal received by the target microphone at, for example, the target display 100.

In various embodiments of the present invention, once the ambient noise has been removed from the received audio signal at, for example, the target display 110, as described above, a number of processes can be implemented to isolate desired audio, such as speech. For example, the detection and isolation of the speech of a customer and a teller near the target display 110 can be desired. In such a case, the teller is assumed to normally speak first after a series of audio tones representing the items purchased. The teller is also assumed to make repetitive statements such as, but not limited to, “your total is . . . ”, “you have saved . . . ”, “Madam”, “Sir”, etc.

In one embodiment of the present invention, by performing a Fourier transform on the audio signals, such as audio representing a conversation between a teller and a customer, the following audio attributes can be detected or determined:
a. frequencies
b. averages amplitudes
c. maximum amplitudes
d. time of first amplitude peak
e. number of amplitude peaks
f. assign a 0 or 1 indicator of whether the voice signal, snippet or segment is likely to be the teller or a customer.

In various embodiments of the present invention, such processing can be performed for example, by an audio card at the target display 110 and/or the central server 140. In various embodiment of the present invention, standard machine learning techniques such as, but not limited to, k-means clustering can use at least the audio attributes determined above along with the audio samples to determine which audio samples represent, for example, a teller's speech and which audio samples represent a customer's speech. As described above and in accordance with the above described embodiments of present invention, audio samples, segments or signals generated in the vicinity of the target display 110 can be determined/isolated.

Once the audio, such as speech generated by a given customer, is isolated, standard machine learning techniques such as, but not limited to, linear regression, decision trees, AdaBoost™ and support vector machines or algorithms can be applied to the isolated audio to attempt to determine information about the audio, for example in the case of speech, the gender, age, ethnic background, etc. of the customer. For example, in one embodiment of the present invention, a database of training datasets can be generated using people of known gender, ages and ethnicity based on the detected frequencies, amplitudes, frequency magnitude peaks, etc. of each person. Afterwards, the training data sets can be used to train a function, algorithm and/or software module such that the function can predict gender, age or ethnic background. It should be noted that it would be beneficial to have the people of a control group speak certain phrases that are often spoken at a checkout counter to help improve the detection of gender, age or ethnicity. It should be also noted that the same process can be applied to audio other than speech, for example, audible tones associated with the scanning of a product. Furthermore, it should also be noted that if actual audio from a specific store in which the method of the present invention is to be implemented can be collected and used to create the training datasets, the accuracy of the function can be further improved based on residual ambient noise, geographical dialects/grammar, and the like.

In alternate embodiments of the present invention, speech to text software could be used to detect certain words or phrases, such as mom, dad, sir, miss, etc., that help to improve the identification of age, gender or ethnicity. In addition, in further alternate embodiments of the present invention, the isolation of a baby crying, cooing, etc. could be used to assume the presence of a family. The determination of purchase information, such as customer attributes including age, gender, ethnicity, family, etc., and other purchase information, such as audible tones associated with the scanning of products in accordance with the various embodiments of the present invention described herein, can be used to provide targeted advertising and ads to a customer(s) via, for example, the target display 110.

In alternate embodiments of the present invention, audio/speech information determined from display microphones as described above can be combined with data collected by a retail environment (e.g., items scanned, loyalty card information, etc.) to increase the accuracy of identifying the gender, age and/or other demographic information of customers. In various embodiments of the present invention, combining the determined customer information with, for example, time stamp information can yield very valuable information. For example, if women are found to shop at specific times of the day, advertising can be shifted to deliver ads more appropriate for women during those times.

In one embodiment of the present invention, once a clean audio pattern of speech is determined, that audio pattern is used to calculate a voice print. The voice print can then be used to pseudo identify a shopper. For example, a significant value is obtained by watching the pattern of visits to the store. If a given voice print can be tracked so as to establish shopper patterns—such as the fact that the shopper visits every Tuesday, or once per week, or every other Wednesday, that data is of high value. Aggregating the data from all detected voice prints can be used to establish overall patterns of shopper frequency. This data can be used to then optimize the advertising periodicity and refresh dates. For example, if this data shows that shoppers typically come in twice per week and it's desired that the media seem new each visit, then the rate at which new media is refreshed can be increased.

In accordance with various described embodiments of the present invention, once a shopper is identified by voice print as described above, that shopper can always be identified using that voice pring, even if the shopper is only being pseudo-identified. In alternate embodiments of the present invention, shopper information gathered by, for example a store, using, for example a loyalty card, can be used to further identify a shopper.

In alternate embodiments of the present invention, audio in the isolated audio signal of the target microphone, besides just speech as described above, can be isolated in accordance with the present invention for use in obtaining information regarding a purchase transaction to improve the effectiveness of advertising by, for example, providing targeted advertising and ads to a customer(s) via, for example, a target display. More specifically, in one embodiment of the present invention, audio tones associated with the scanning of an item to be purchased can recorded by a microphone of a target display and can be used to determine a number items purchased by a particular customer. In addition, such information can be combined with information retained by a retailer regarding what items were purchased, for example at a particular time at a particular register, and specific purchased items can be associated with a particular customer.

In accordance with various embodiments of the present invention, isolated audio recorded by a microphone that has been isolated as described above can be used in obtaining information regarding a purchase transaction to improve the effectiveness of advertising by, for example, providing targeted advertising and ads to a customer(s) via, for example, the target display as described above.

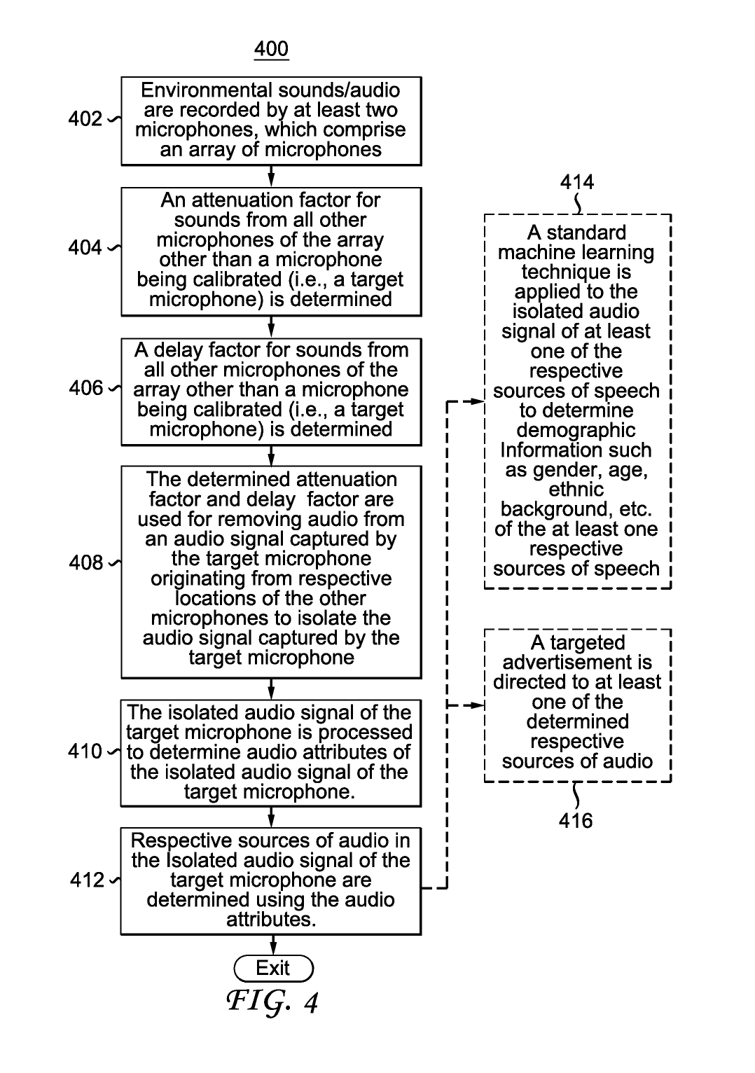

FIG. 4 depicts a flow diagram of a method for the isolation of microphone audio in accordance with an embodiment of the present invention. The method 400 of FIG. 4 begins at step 402 during which environmental sounds/audio are recorded by at least two microphones, which comprise an array of microphones. The method 400 proceeds to step 404.

At step 404, an attenuation factor for sounds from all other microphones of the array other than a microphone being calibrated (i.e., a target microphone) is determined using, for example, known sounds from locations of the other microphones of the array. The method 400 proceeds to step 406.

At step 406, a delay factor for sounds from all other microphones of the array other than a microphone being calibrated (i.e., a target microphone) is determined using, for example, known sounds from locations of the other microphones of the array. The method 400 proceeds to step 408.

At step 408, the determined attenuation factor and delay factor are implemented for removing audio from an audio signal captured by the target microphone originating from respective locations of the other microphones of the array of microphones from an audio signal captured by the target microphone to isolate the audio signal captured by the target microphone for example by, in one embodiment of the present invention, using beam forming processes/techniques. The method 400 proceeds to step 410.

At step 410, the isolated audio signal of the target microphone is processed to determine audio attributes of the isolated audio signal of the target microphone. For example and as described above, in one embodiment of the present invention audio attributes of speech such as frequency, average amplitude, maximum amplitude, time of first amplitude peak, and number of amplitude peaks in the isolated speech of the target microphone can be determined by performing a Fourier transform on the isolated audio signals. The method 400 then proceeds to step 412.

At step 412, respective sources of audio in the isolated audio signal of the target microphone are determined using the audio attributes. As described above, in one embodiment of the present invention, sources of speech in the isolated audio signal of the target microphone are determined by applying standard machine learning techniques to the isolated audio signal and applying the determined speech attributes. The method 400 can then proceed to optional steps 414 or 416 or can be exited.

At optional step 414, a standard machine learning technique is applied to the isolated audio signal of at least one of the respective sources of audio, such as speech to determine demographic information such as gender, age, ethnic background, etc. of the at least one respective sources of speech.

At optional step 416, a targeted advertisement is directed to at least one of the determined respective sources of audio. For example, as described above in one embodiment of the present invention, targeted advertising and ads can be presented to an identified/determined customer(s) via, for example, the target display.

Having described various embodiments of a method, apparatus and system for isolating microphone audio (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A method, comprising:
recording audio using at least two microphones, which comprise an array of microphones;
using a target microphone of the array of microphones, determining an attenuation factor for audio originating from respective locations of other microphones of the array of microphones;
using a target microphone of the array of microphones, determining a delay factor for audio originating from respective locations of other microphones of the array of microphones;
implementing said determined attenuation factor and delay factor for removing audio originating from respective locations of the other microphones of the array of microphones from an audio signal captured by the target microphone to isolate the audio signal captured by the target microphone;
processing the isolated audio signal of the target microphone to determine audio attributes of the isolated audio signal of the target microphone; and
determining, using the audio attributes, respective sources of audio in the isolated audio signal of the target microphone.

2. The method of claim 1, wherein said audio attributes comprise speech attributes and respective sources of speech in the isolated audio signal of the target microphone are determined.

3. The method of claim 2, wherein said processing comprises applying a Fourier transform to the isolated audio signal of the target microphone to determine attributes of speech in the audio signal.

4. The method of claim 3, wherein said attributes of speech include at least one of frequency, average amplitude, maximum amplitude, time of first amplitude peak, and number of amplitude peaks.

5. The method of claim 2, wherein determining respective sources of speech in the isolated audio signal includes applying a machine learning technique to the isolated audio signal and applying the determined speech attributes.

6. The method of claim 5, wherein the machine learning technique comprises k-means clustering.

7. The method of claim 2, comprising applying a standard machine learning technique to the isolated audio signal of at least one of the respective sources of speech to determine demographic information of the at least one respective sources of speech.

8. The method of claim 7, wherein the standard machine learning technique includes at least one of linear regression, decision trees, AdaBoost™ and support vector machines or algorithms.

9. The method of claim 7, wherein the demographic information includes at least one of gender, age, and ethnic background of the source of speech.

10. The method of claim 2, comprising determining a voice print for the respective sources of speech using the speech attributes.

11. The method of claim 1, wherein said audio characteristics comprise audio characteristics of audible tones associated with a purchase of a product and a number of products purchased are determined from the audible tones.

12. The method of claim 1, comprising using information collected by a retailer to identify the respective sources of audio in the isolated audio signal of the target microphone.

13. The method of claim 1, comprising providing targeted advertising for the determined respective sources of audio.

14. An apparatus, comprising:
a memory for storing program routines and data; and
a processor for executing said program routines;
said apparatus configured to:
record audio using at least two microphones, which comprise an array of microphones;
use a target microphone of the array of microphones to determine an attenuation factor for audio originating from respective locations of other microphones of the array of microphones;
use a target microphone of the array of microphones to determine a delay factor for audio originating from respective locations of other microphones of the array of microphones;
implement said determined attenuation factor and delay factor for removing audio originating from respective locations of the other microphones of the array of microphones from an audio signal captured by the target microphone to isolate the audio signal captured by the target microphone;
process the isolated audio signal of the target microphone to determine audio attributes of the isolated audio signal of the target microphone; and
determine, using the audio attributes, respective sources of audio in the isolated audio signal of the target microphone.

15. The apparatus of claim 14, wherein said apparatus comprises an integrated audio circuit of at least one of a server and a set-top box.

16. A system, comprising:
at least two microphones comprising an array of microphones;
at least one audio source;
an apparatus including a memory for storing program routines and data, and a processor for executing said program routines, said apparatus configured to:
record audio using at least two microphones, which comprise an array of microphones;
use a target microphone of the array of microphones to determine an attenuation factor for audio originating from respective locations of other microphones of the array of microphones;
use a target microphone of the array of microphones to determine a delay factor for audio originating from respective locations of other microphones of the array of microphones;
implement said determined attenuation factor and delay factor for removing audio originating from respective locations of the other microphones of the array of microphones from an audio signal captured by the target microphone to isolate the audio signal captured by the target microphone;
process the isolated audio signal of the target microphone to determine audio attributes of the isolated audio signal of the target microphone; and
determine, using the audio attributes, respective audio sources in the isolated audio signal of the target microphone.

17. The system of claim 16, wherein said at least two microphones comprise microphones of at least one network audio processor.

18. The system of claim 16, wherein said at least two microphones comprise microphones in a check-out lane of a retail environment.

19. The system of claim 16, wherein said at least one audio source comprises a scanner.

20. The system of claim 16, wherein said at least one audio source comprises a teller and a customer.
